(19) United States
(12) Patent Application Publication
(10) Pub. No.: US 2026/0266674 A1
(43) Pub. Date: Sep. 10, 2026

(54) TACTILE SENSOR MODULE, TACTILE SENSOR MODULE TRAINING SYSTEM, AND TACTILE SENSOR SYSTEM

(71) Applicant: KOREA ADVANCED INSTITUTE OF SCIENCE AND TECHNOLOGY, Daejeon (KR)

(72) Inventors: Inkyu PARK, Daejeon (KR); Hyunjin KIM, Daejeon (KR); Jungrak CHOI, Daejeon (KR)

(73) Assignee: KOREA ADVANCED INSTITUTE OF SCIENCE AND TECHNOLOGY, Daejeon (KR)

(21) Appl. No.: 19/166,264

(22) PCT Filed: Mar. 8, 2024
(86) PCT No.: PCT/KR2024/002986

§ 371 Date: Sep. 17, 2025

(30) Foreign Application Priority Data
Mar. 17, 2023 (KR) 10-2023-0035053

(51) Int. Cl. G01L 5/166; G01L 1/24; G01L 25/00

(52) U.S. Cl. CPC G01L 5/166; G01L 1/24; G01L 25/00

(57) ABSTRACT

The present disclosure relates to a tactile sensor module. The tactile sensor module includes: a plate-shaped upper layer portion; a plate-shaped lower layer portion disposed to face the upper layer portion; and a transparent buffer portion filled in between the upper layer portion and the lower layer portion, wherein the upper layer portion includes an upper layer connector and a plurality of light-emitting diodes that are lit sequentially according to a control signal input to the upper layer connector, and the lower layer portion includes a lower layer connector disposed at one side thereof and a plurality of photodiodes on which light emitted from the plurality of light-emitting diodes is incident and which output signals according to respective amounts of light received, through the lower layer connector.

### TECHNICAL FIELD

The present disclosure relates to a tactile sensor module, a tactile sensor module training system, and a tactile sensor system and, more particularly, to a tactile sensor module comprising a plurality of light-emitting diodes and a plurality of photodiodes, a tactile sensor module training system configured to learn 3-axis force and 3-axis torque based on an output of the photodiodes of the tactile sensor module, and a tactile sensor system implemented with the tactile sensor module.

### BACKGROUND ART

As efforts to apply the five human senses of sight, hearing, smell, taste, and touch to machines have long been made, related sensor development technologies are becoming increasingly diverse. In particular, as the demand for smartphones and wearable devices increases, a signal transmission method based on tactile sensation is being recognized as an important means.

A tactile sensor is a sensor that measures contact parameters between the sensor and an object, that is, local forces or pressures affected by contact, and means any system or device developed to enable a machine to perceive the texture of stimuli, weight, magnitude of external forces transmitted to the skin, and temperature perceived by human skin from the external environment.

The tactile sensor may be utilized in various industries, including augmented reality/virtual reality, health monitoring, and telehaptics. The tactile sensor detects fine variations on the surface of an object and converts them into electrical signals, and the number of sensors, the connection configuration, and the mobility of measurement are determined depending on the body attachment position and the intended purpose. That is, the tactile sensor may be attached to various parts of the body, such as the fingers, wrist, and waist, and its size and shape may vary based on the body part to which it is attached.

Since the tactile sensor measures local force and pressure, a tactile sensor system is implemented by arranging a plurality of tactile sensors in an array at different positions. The tactile sensor array may record a pattern of measured values from respective tactile sensors upon contact with a specific object or surface, and extract information such as the shape, weight, and texture of the object or surface by recognizing the pattern. Wiring methods of the tactile sensor array include a one-to-one connection method and a matrix connection method, and such conventional wiring methods of the tactile sensor array have a problem in that, as the number of tactile sensors forming the array increases, the number of signal lines also increases, resulting in increased complexity.

In addition, there is a problem in that when the number of tactile sensors forming the array or the size and shape of the body part to which the tactile sensor array is attached changes, it is necessary to determine the number of tactile sensors according to the size and shape, design the arrangement of the tactile sensors, and wire the arranged tactile sensors, thereby requiring separate design and production and increasing production cost.

As such, the conventional tactile sensors and tactile sensor arrays are still at a stage with significant performance deficiencies, and the manufacturing process is not simple, so continuous research on tactile sensors is required.

### DETAILED DESCRIPTION OF INVENTION

### Technical Problems

An objective of the present disclosure is to provide a tactile sensor module capable of measuring 3-axis force and 3-axis torque based on a plurality of light-emitting diodes and a plurality of photodiodes.

Another objective of the present disclosure is to provide a tactile sensor module training system capable of determining 3-axis force and 3-axis torque by training an output of a tactile sensor module with an artificial neural network.

Another objective of the present disclosure is to provide a tactile sensor system capable of detecting 3-axis force and 3-axis torque using a single tactile sensor module and a trained artificial neural network.

Another objective of the present disclosure is to provide a tactile sensor system capable of detecting 3-axis force and 3-axis torque of a plurality of tactile sensor modules using a tactile sensor array formed by connecting a plurality of tactile sensor modules and a trained artificial neural network.

### Technical Solution

The present disclosure can be implemented in various forms, including a device (system), a method, a computer program stored in a computer-readable medium, or a computer-readable medium in which a computer program is stored.

A tactile sensor module according to an embodiment of the present invention includes a plate-shaped upper layer portion, a plate-shaped lower layer portion disposed to face the upper layer portion, and a transparent buffer portion filled between the upper layer portion and the lower layer portion. The upper layer portion includes an upper layer connector disposed on one side and a plurality of light-emitting diodes configured to be sequentially lit according to a control signal input to the upper layer connector. The lower layer portion includes a lower layer connector disposed on one side and a plurality of photodiodes configured to receive light emitted from the plurality of light-emitting diodes and to output signals corresponding to respective amounts of received light through the lower layer connector.

Preferably, the upper layer portion further includes an upper layer socket to which a subsequent tactile sensor module is connected, on at least one of remaining sides other than the side on which the upper layer connector is installed, and the lower layer portion further includes a lower layer socket to which a subsequent tactile sensor module is connected, on at least one of remaining sides other than the side on which the lower layer connector is installed.

More preferably, the upper layer portion further includes at least two upper layer sockets connected in parallel to each other on at least two sides, and the lower layer portion further includes at least two lower layer sockets connected in parallel to each other on at least two sides.

Preferably, the transparent buffer portion is made of a transparent and elastic material so as to be deformed when a force or a torque is applied to any position of at least one of the upper layer portion and the lower layer portion.

A tactile sensor module training system according to an embodiment of the present invention includes: a tactile sensor module including an upper layer portion that has an upper layer connector disposed on one side and a plurality of light-emitting diodes configured to be sequentially lit according to a control signal input to the upper layer connector, and a lower layer portion that has a lower layer connector disposed on one side and a plurality of photodiodes configured to receive light emitted from the plurality of light-emitting diodes and to output signals corresponding to respective amounts of received light through the lower layer connector; an MCU configured to output a control signal so that the plurality of light-emitting diodes installed in the tactile sensor module sequentially emit light, and to receive signals corresponding to amounts of received light from the plurality of photodiodes while the plurality of light-emitting diodes sequentially emit light; an actual value output unit configured to output a 3-axis force and a 3-axis torque actually applied to the tactile sensor module; and an artificial neural network configured to be trained to minimize an error between an estimated 3-axis force and 3-axis torque and an actual 3-axis force and 3-axis torque provided by the actual value output unit, wherein the artificial neural network estimates the 3-axis force and the 3-axis torque applied to the tactile sensor module based on information on the amounts of light received by the plurality of photodiodes according to emission of the plurality of light-emitting diodes input through the MCU.

Preferably, the tactile sensor module is connected to the MCU through the upper layer connector and the lower layer connector.

Preferably, the actual value output unit includes a load cell configured to receive the 3-axis force and the 3-axis torque that are equally applied to the tactile sensor module, and to measure the applied 3-axis force and 3-axis torque.

Preferably, the actual value output unit includes an actuator configured to determine the 3-axis force and the 3-axis torque applied to the tactile sensor module and to apply them to the tactile sensor module.

Preferably, the actual value output unit includes a storage means configured to store the 3-axis force and the 3-axis torque applied to the tactile sensor module.

Preferably, the upper layer portion further includes an upper layer socket to which a subsequent tactile sensor module is connected, on at least one of the remaining sides other than the side on which the upper layer connector is installed, and the lower layer portion further includes a lower layer socket to which a subsequent tactile sensor module is connected, on at least one of the remaining sides other than the side on which the lower layer connector is installed.

More preferably, the upper layer portion further includes at least two upper layer sockets connected in parallel to each other on at least two sides, and the lower layer portion further includes at least two lower layer sockets connected in parallel to each other on at least two sides.

A tactile sensor system according to an embodiment of the present invention includes: a first tactile sensor module including a first upper layer portion that has a first upper layer connector disposed on one side and a first plurality of light-emitting diodes configured to be sequentially lit according to a control signal input to the first upper layer connector, and a first lower layer portion that has a first lower layer connector disposed on one side and a first plurality of photodiodes configured to receive light emitted from the first plurality of light-emitting diodes and to output signals according to respective amounts of light received through the first lower layer connector; an MCU configured to output a control signal so that the first plurality of light-emitting diodes installed on the first tactile sensor module sequentially emit light, and to receive signals corresponding to amounts of light received by the first plurality of photodiodes while the first plurality of light-emitting diodes sequentially emit light; and a trained artificial neural network configured to estimate a 3-axis force and a 3-axis torque applied to the first tactile sensor module based on information on the amounts of light received by the first plurality of photodiodes according to emission of the first plurality of light-emitting diodes input through the MCU.

Preferably, the first tactile sensor module is connected to the MCU through the first upper layer connector and the first lower layer connector.

Preferably, the first upper layer portion further includes a first upper layer socket to which a subsequent tactile sensor module is connected, on at least one of the remaining sides other than the side on which the first upper layer connector is installed, and the first lower layer portion further includes a first lower layer socket to which a subsequent tactile sensor module is connected, on at least one of the remaining sides other than the side on which the first lower layer connector is installed.

More preferably, the tactile sensor system further includes a second tactile sensor module which includes a second upper layer portion that has a second upper layer connector disposed on one side and connected to the first upper layer socket, and a second plurality of light-emitting diodes configured to be sequentially lit according to a control signal input to the second upper layer connector; and a second lower layer portion that has a second lower layer connector disposed on one side and connected to the first lower layer socket, and a second plurality of photodiodes configured to receive light emitted from the second plurality of light-emitting diodes and to output signals according to respective amounts of light received through the second lower layer connector.

More preferably, the MCU is configured to transmit, through the first upper layer connector of the first tactile sensor module, a control signal for sequentially lighting the first plurality of light-emitting diodes and the second plurality of light-emitting diodes installed on the first tactile sensor module and the second tactile sensor module, respectively.

More preferably, the first tactile sensor module takes bits assigned to itself from the control signal provided by the MCU, sequentially lights the first plurality of light-emitting diodes, and delivers remaining bits to the second tactile sensor module.

More preferably, the MCU is configured to receive, through the first lower layer connector of the first tactile sensor module, information on the amounts of light received by the first plurality of photodiodes and the second plurality of photodiodes installed on the first tactile sensor module and the second tactile sensor module, respectively.

More preferably, the trained artificial neural network estimates a 3-axis force and a 3-axis torque applied to the second tactile sensor module based on information on the amounts of light received by the second plurality of photodiodes according to emission of the second plurality of light-emitting diodes input through the MCU.

More preferably, the first upper layer portion further includes at least two first upper layer sockets connected in parallel to each other on at least two sides, and the first lower layer portion further includes at least two first lower layer sockets connected in parallel to each other on at least two sides.

### Effect of Invention

In accordance with the present disclosure, a tactile sensor module having a simple structure can be provided by manufacturing the tactile sensor module using a plurality of light-emitting diodes and a plurality of photodiodes.

In accordance with the present disclosure, by training an output of a tactile sensor module with an artificial neural network, 3-axis force and 3-axis torque can be determined from the output of the tactile sensor module.

In accordance with the present disclosure, 3-axis force and 3-axis torque applied to a tactile sensor module can be detected using a tactile sensor module and a trained artificial neural network.

In accordance with the present disclosure, a plurality of tactile sensor modules are connected in an array such that 3-axis force and 3-axis torque can be detected from each tactile sensor module over a wide area, and an address can be assigned to each tactile sensor module.

In accordance with the present disclosure, when a plurality of tactile sensor modules are connected in an array, the connected tactile sensor modules share a signal line, such that the wiring complexity of the tactile sensor system does not increase even if the tactile sensor module array is extended.

In accordance with the present disclosure, since a subsequent tactile sensor module may be selectively connected in one of three directions of the tactile sensor module to extend the system, the design flexibility according to the mounting position, shape, and size of the tactile sensor system is increased, and the time, effort, and cost required for the design may be reduced.

In accordance with the present disclosure, since a tactile sensor system is configured by connecting modular tactile sensor modules, the tactile sensor system can be reconfigured according to user preferences and convenience, and the tactile sensor modules can be reused.

In accordance with the present disclosure, since modular tactile sensor modules are manufactured and can be freely connected to configure a tactile sensor system of a desired shape, mass production of tactile sensor modules is possible, thereby reducing manufacturing costs.

Effects of the present disclosure are not limited to the above-mentioned effects, and other effects that are not mentioned above will be clearly understood by those skilled in the art from the claims.

### BRIEF DESCRIPTION OF THE DRAWINGS

Embodiments of the present disclosure will be described with reference to the accompanying drawings set forth below, wherein like reference numerals denote like components, but are not limited thereto.

FIG. 1a is a side view showing a tactile sensor module according to one embodiment of the present disclosure.

FIG. 1b is a view showing a surface of an upper layer portion in contact with a transparent buffer portion according to the present disclosure.

FIG. 1c is a view showing a surface of a lower layer portion in contact with the transparent buffer portion according to the present disclosure.

FIG. 2 is a block diagram showing a tactile sensor module training system according to the present disclosure.

FIG. 3 is a graph showing the results of evaluating the force-torque estimation performance of a trained artificial neural network according to the present disclosure.

FIG. 4 is a block diagram showing a tactile sensor system composed of a single tactile sensor module according to the present disclosure.

FIG. 5 is a block diagram showing a tactile sensor system composed of a tactile sensor module array according to the present disclosure.

FIG. 6 is a diagram showing various embodiments of the tactile sensor module array according to the present disclosure.

[DESCRIPTION OF REFERENCE NUMERALS]

| | |
|---|---|
| 100: tactile sensor module | 110: upper layer portion |
| 120: lower layer portion | 130: transparent buffer portion |
| 111: upper layer connector | 112: upper layer socket |
| 121: lower layer connector | 122: lower layer socket |
| 113-1, 113-2, 113-3, 113-4: | |
| light-emitting diodes | |
| 123-1, 123-2: photodiodes | |

### BEST MODE FOR CARRYING OUT THE INVENTION

Hereinafter, specific details for implementing the present disclosure will be described in detail with reference to the accompanying drawings. However, in the following description, detailed explanations of well-known functions or configurations will be omitted if they are deemed to unnecessarily obscure the gist of the present disclosure.

The same reference numerals are used throughout the drawings to designate the same or corresponding components. In the following descriptions of the embodiments, the same or corresponding components may not be repeatedly described. However, the omission of such descriptions does not imply that the components are not included in the corresponding embodiments.

The advantages and features of the embodiments disclosed in this specification, as well as methods for achieving them, will become apparent from the embodiments described below with reference to the accompanying drawings. However, the present disclosure is not limited to the embodiments disclosed below and may be implemented in various other forms, and these embodiments are merely provided to illustrate the scope of the present disclosure to those skilled in the art.

Unless otherwise defined, all terms (including technical and scientific terms) used in this specification shall have the meanings commonly understood by those skilled in the art to which the present disclosure pertains. Terms that are defined in commonly used dictionaries shall not be interpreted in an idealized or overly formal sense unless explicitly defined otherwise.

For example, the term “technology” may refer to systems, methods, computer-readable instructions, modules, algorithms, hardware logic, and/or operations throughout this specification, as permitted by the context described above.

The terms used in this specification will be briefly explained, followed by a detailed description of the disclosed embodiments. While the terms used herein have been selected as commonly used and widely accepted expressions, taking into account the functions of the present disclosure, they may vary depending on the intent of a person skilled in the art, case law, or the emergence of new technologies. In addition, certain terms may have been arbitrarily selected by the applicant in specific cases, in which case their meanings will be specifically defined in the relevant description of the present disclosure. Therefore, the terms used in the present disclosure should not be interpreted merely by their literal names, but should be understood based on their intended meanings and the overall context of the present disclosure.

In the present disclosure, the singular forms include the plural forms as well, unless the context clearly indicates otherwise. In addition, the plural forms include the singular forms unless the context clearly indicates otherwise. Throughout this specification, when a part is described as “including” a certain component, it does not exclude the presence of other components unless explicitly stated otherwise, but rather indicates that other components may also be included.

It will be further understood that the terms “comprise”, “comprising”, and the like, when used in this specification, specify the presence of stated features, steps, operations, elements, and/or components, but do not preclude the addition of one or more other features, steps, operations, elements, components, and/or combinations thereof.

In the present disclosure, when a particular component is described as being “coupled,” “combined,” “connected,” “associated,” or “responsive” to another component, it may be directly coupled, combined, connected, associated with, or responsive to the other component, but is not limited thereto. For example, one or more intervening components may be present between a specific component and another component. In addition, the term “and/or” in the present disclosure may include each of the listed items individually or any combination thereof.

It will be understood that, although the terms “first”, “second”, and the like may be used herein to distinguish one component from another component, these terms are not to be construed as limiting the components. For example, a “first” component may be used to refer to a component that is identical or similar in form to a “second” component.

Artificial Intelligence (AI) refers to a field of study that researches artificial intelligence or methodologies capable of creating it, and Machine Learning refers to a field of study that defines various problems in the field of artificial intelligence and researches methodologies for solving them. Machine Learning may also be defined as an algorithm that enhances performance on a certain task through continuous experience.

An Artificial Neural Network (ANN) is a model used in machine learning, which may refer to a model having problem-solving capability, the model being composed of artificial neurons (nodes) forming a network through synaptic connections. The artificial neural network may be defined by a connection pattern between neurons of different layers, a learning process that updates learning parameters within the model, and an activation function that generates an output.

The artificial neural network may include an input layer, an output layer, and optionally one or more hidden layers. Each layer includes one or more neurons, and the artificial neural network may include synapses connecting the neurons to each other. In the artificial neural network, each neuron may output a value of an activation function with respect to input signals received through synapses, weights of each layer, and a bias.

Learning parameters of the model refer to parameters determined through training, and include weights of synaptic connections and biases of neurons. Hyperparameters refer to parameters to be set prior to training in a machine learning algorithm, and include a learning rate, iterations, a mini-batch size, and an initialization function.

An objective of training of the artificial neural network may be considered as determining learning parameters that minimize a loss function. The loss function may be used as a metric for determining optimal learning parameters in the training process of the artificial neural network.

Machine learning may be classified into supervised learning, unsupervised learning, and reinforcement learning according to a learning approach.

Supervised learning refers to a method of training an artificial neural network when training data are provided with labels, and a label may refer to a correct answer (or output result) that the artificial neural network is to infer when the training data are input to the artificial neural network. Unsupervised learning may refer to a method of training an artificial neural network when training data are not provided with labels. Reinforcement learning may refer to a learning method of training an agent defined within an environment to select an action or a sequence of actions that maximizes cumulative rewards in each state.

Machine learning implemented with a deep neural network (DNN) including a plurality of hidden layers is also referred to as deep learning, and deep learning is a part of machine learning. Hereinafter, machine learning is used in a sense including deep learning. Artificial intelligence may be implemented by an artificial neural network module.

### Tactile Sensor Module

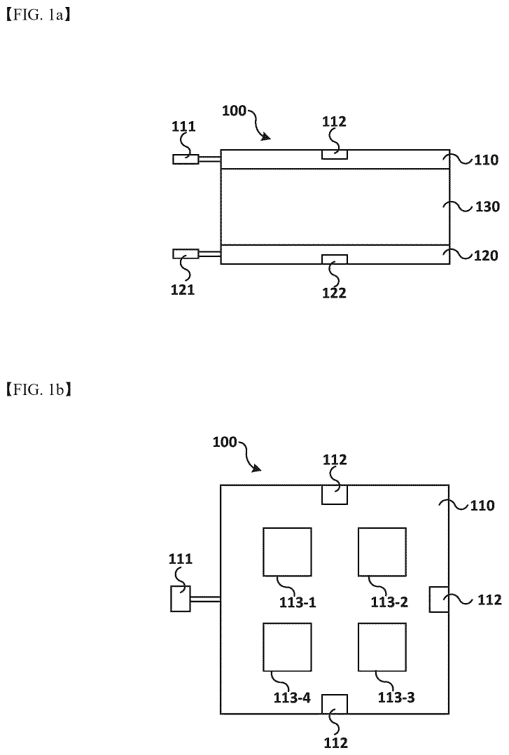

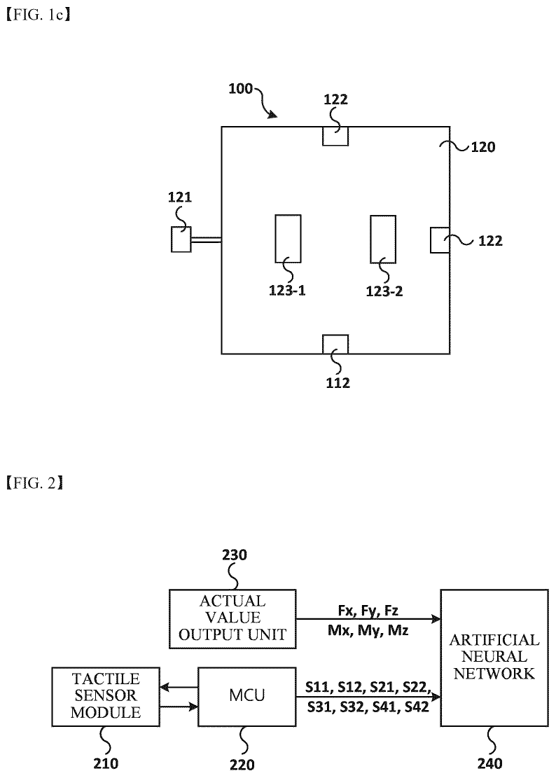

FIG. 1a is a side view showing a tactile sensor module 100 according to one embodiment of the present disclosure.

The tactile sensor module 100 includes a plate-shaped upper layer portion 110, a plate-shaped lower layer portion 120 disposed to face the upper layer portion 110, and a transparent buffer portion 130 filled between the upper layer portion 110 and the lower layer portion 120. Each of the upper layer portion 110 and the lower layer portion 120 may be a square plate having four sides.

On one side of the upper layer portion 110, an upper layer connector 111 is installed, which is connected to the MCU (microcontroller unit) or to an upper layer socket of a preceding tactile sensor module. On at least one of the other sides of the upper layer portion 110, an upper layer socket 112 is installed, to which an upper layer connector of a subsequent tactile sensor module is connected. As another embodiment, an upper layer connector 111 may be installed on one side of the upper layer portion 110, and an upper layer socket 112 may be installed on each of the other three sides.

On one side of the lower layer portion 120 corresponding to the upper layer connector 111 of the upper layer portion 110, a lower layer connector 121 is installed, which is connected to the MCU (microcontroller unit) or to a lower layer socket of a preceding tactile sensor module. Further, on the other sides of the lower layer portion 120 corresponding to the upper layer socket 112 of the upper layer portion 110, a lower layer socket 122, to which a lower layer connector of a subsequent tactile sensor module is connected, may be installed.

Preferably, the transparent buffer portion 130 is composed of an elastic material such that it is elastically deformed when a force or a torque is applied to any position of the upper layer portion 110 or the lower layer portion 120 of the tactile sensor module 100. The transparent buffer portion 130 may be implemented with a transparent and elastic material. Such a material may include at least one of elastomer, silicone elastomer, polyurethane elastomer, TPU (thermoplastic polyurethane), PETG (polyethylene terephthalate glycol), PC (polycarbonate), and the like.

FIG. 1b is a view showing a surface of the upper layer portion in contact with the transparent buffer portion according to the present disclosure.

The upper layer portion 110 may include an upper layer connector 111 installed on one side, and a plurality of light-emitting diodes 113-1, 113-2, 113-3, and 113-4 that are sequentially lit in response to a control signal input through the upper layer connector 111. And, the upper layer portion 110 may further include at least one upper layer socket 112 installed on at least one of the other sides of the upper layer portion 110, other than the side on which the upper layer connector 111 is installed. The plurality of light-emitting diodes 113-1, 113-2, 113-3, and 113-4 may consist of four diodes. The upper layer connector 111 may include a single signal line that sequentially transmits lighting control signals to the four light-emitting diodes 113-1, 113-2, 113-3, and 113-4.

FIG. 1c is a view showing a surface of the lower layer portion in contact with the transparent buffer portion according to the present disclosure.

The lower layer portion 120 may include a lower layer connector 121 installed on one side corresponding to the upper layer connector 111, and a plurality of photodiodes 123-1 and 123-2 that receive light emitted from the plurality of light-emitting diodes 113-1, 113-2, 113-3, and 113-4 installed on the upper layer portion 110 and output electric signals according to an amount of received light through the lower layer connector 121. In addition, the lower layer portion 120 may further include at least one lower layer socket 122 installed on at least one of the other sides of the lower layer portion 120, other than the side on which the lower layer connector 121 is installed. The plurality of photodiodes 123-1 and 123-2 may consist of two photodiodes. The lower layer connector 121 may include two signal lines that respectively transmit output signals of the two photodiodes 123-1 and 123-2 to the outside.

The four light-emitting diodes 113-1, 113-2, 113-3, and 113-4 of the upper layer portion 110 and the two photodiodes 123-1 and 123-2 of the lower layer portion 120 are disposed to face each other through the transparent buffer portion 130. When the light-emitting diodes 113-1, 113-2, 113-3, and 113-4 are sequentially lit, the plurality of photodiodes 123-1 and 123-2 receive light emitted from the light-emitting diodes through the transparent buffer portion 130. At this time, the amount of light received by each photodiode varies depending on the distance between the light-emitting diode and each photodiode. When a force or a torque is applied in any direction to the tactile sensor module 100, the distance and/or angle between the upper layer portion 110 and the lower layer portion 120 is deformed by the transparent buffer portion 130, which causes the amount of light received by the photodiodes to change.

Principle of Force and Torque Measurement of the Tactile Sensor Module according to the Present Invention

In the present disclosure, by using such a principle, 3-axis force and 3-axis torque are measured based on the amounts of light received by the two photodiodes when the four light-emitting diodes are lit.

When the first light-emitting diode 113-1 is lit, the amount of light received by the first photodiode 123-1 is referred to as S11, and the amount of light received by the second photodiode 123-2 is referred to as S12. When the second light-emitting diode 113-2 is lit, the amount of light received by the first photodiode 123-1 is referred to as S21, and the amount of light received by the second photodiode 123-2 is referred to as S22. When the third light-emitting diode 113-3 is lit, the amount of light received by the first photodiode 123-1 is referred to as S31, and the amount of light received by the second photodiode 123-2 is referred to as S32. When the fourth light-emitting diode 113-4 is lit, the amount of light received by the first photodiode 123-1 is referred to as S41, and the amount of light received by the second photodiode 123-2 is referred to as S42.

By dividing a tactile sensing cycle T into four periods, one of the first light-emitting diode 113-1 to the fourth light-emitting diode 113-4 is lit sequentially during each respective period, and while each light-emitting diode is lit, electric signals according to the amount of light received are obtained respectively from the first photodiode 123-1 and the second photodiode 123-2.

Then, during one cycle, values of S11, S12, S21, S22, S31, S32, S41, and S42 may be obtained. The amounts of light received by the first photodiode 123-1 and the second photodiode 123-2 may vary depending on the 3-axis force and 3-axis torque applied to the tactile sensor module. In the present disclosure, an artificial neural network is used to learn the amounts of light received by the first photodiode 123-1 and the second photodiode 123-2, thereby determining the 3-axis force and 3-axis torque.

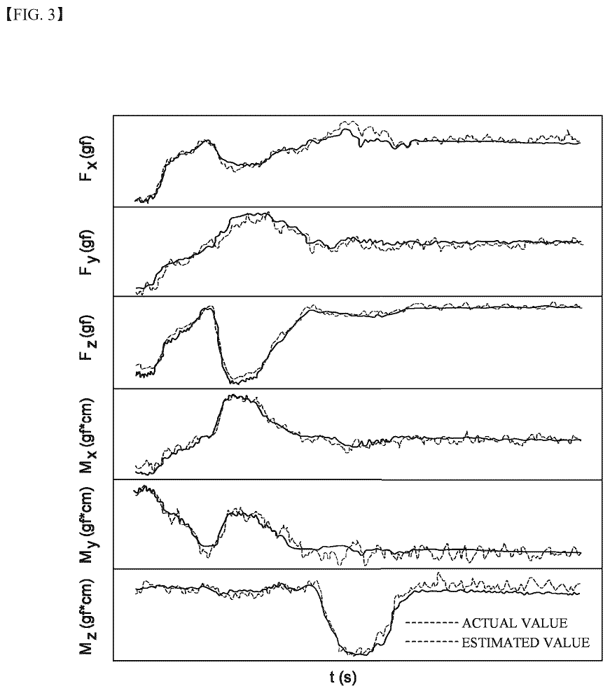

FIG. 2 is a block diagram showing a tactile sensor module training system according to the present disclosure.

The tactile sensor module training system according to the present disclosure includes: an MCU 220 that outputs a control signal so that a plurality of light-emitting diodes installed on a tactile sensor module 210 sequentially emit light, and receives signals according to the amounts of light received by a plurality of photodiodes while the plurality of light-emitting diodes sequentially emit light; an actual value output unit 230 that outputs a 3-axis force and a 3-axis torque actually applied to the tactile sensor module 210; and an artificial neural network 240 that is configured to receive, from the MCU 220, data on the amounts of light received by the plurality of photodiodes corresponding to the emission of the plurality of light-emitting diodes, estimate the 3-axis force and 3-axis torque applied to the tactile sensor module 210, and be trained such that an error between the estimated values of the 3-axis force and 3-axis torque and the actual values of the 3-axis force and 3-axis torque provided by the actual value output unit 230 is minimized. The tactile sensor module 210 of FIG. 2 may be the tactile sensor module 100 of FIGS. 1a to 1c.

The tactile sensor module 210 is connected to the MCU 220 through an upper layer connector and a lower layer connector. The MCU 220 outputs a control signal through the upper layer connector to the tactile sensor module 210 so that, in each cycle, the first light-emitting diode 113-1 to the fourth light-emitting diode 113-4 are sequentially lit. When the first light-emitting diode 113-1 to the fourth light-emitting diode 113-4 are lit, light is incident on the first photodiode 123-1 and the second photodiode 123-2, and the first photodiode 123-1 and the second photodiode 123-2 transmit signals corresponding to the amounts of light received to the MCU 220 through the lower layer connector. Through this, the MCU 220 may obtain information on the amounts of light received (S11, S12, S21, S22, S31, S32, S41, and S42) of the two photodiodes when the four light-emitting diodes are lit in each cycle.

In one embodiment, the actual value output unit 230 may include a load cell that receives the same 3-axis force and 3-axis torque applied to the tactile sensor module 210 and measures the applied 3-axis force and 3-axis torque. In another embodiment, the actual value output unit 230 may include an actuator that determines the 3-axis force and 3-axis torque applied to the tactile sensor module 210 and applies them to the tactile sensor module 210. In a further embodiment, the actual value output unit 230 may include a storage means that stores the 3-axis force and 3-axis torque applied to the tactile sensor module 210. In this case, the actual values of the 3-axis force and 3-axis torque provided from the actual value output unit 230 may also be provided through the MCU 220 to the artificial neural network 240.

The artificial neural network 240 estimates the 3-axis force and 3-axis torque applied to the tactile sensor module 210, based on information received from the MCU 220 regarding the amounts of light received (S11, S12, S21, S22, S31, S32, S41, and S42) by the plurality of photodiodes when the plurality of light-emitting diodes are lit. The artificial neural network 240 is trained such that an error between the actual values of the 3-axis force and 3-axis torque provided by the actual value output unit 230 and the estimated values of the 3-axis force and 3-axis torque is minimized.

In the present disclosure, the term “trained artificial neural network” refers to an artificial neural network trained, through the tactile sensor module training system of FIG. 2, to estimate the 3-axis force and 3-axis torque applied to the tactile sensor module 210 based on the information on the amounts of light received by the plurality of photodiodes while the plurality of light-emitting diodes of the tactile sensor module of the present disclosure sequentially emit light.

FIG. 3 is a graph showing the results of evaluating the force-torque estimation performance of a trained artificial neural network according to the present disclosure.

As shown in FIG. 3, it was confirmed that the 3-axis force and 3-axis torque can be measured using the tactile sensor module of the present disclosure and the trained artificial neural network, as there is almost no error between the actual values and the values predicted by the trained artificial neural network for the applied 3-axis force (Fx, Fy, Fz) and 3-axis torque (Mx, My, Mz).

### Tactile Sensor System

The tactile sensor module 100 or 210 of the present disclosure may be configured as a single unit or an array to be implemented as a tactile sensor system.

FIG. 4 is a block diagram showing a tactile sensor system composed of a single tactile sensor module according to the present disclosure.

The tactile sensor system includes: a tactile sensor module 410 including an upper layer portion in which an upper layer connector and a plurality of light-emitting diodes are installed, and a lower layer portion in which a lower layer connector and a plurality of photodiodes disposed to face the plurality of light-emitting diodes are installed; an MCU 420 that is connected to the tactile sensor module 410 through the upper layer connector and the lower layer connector, outputs a control signal through the upper layer connector so that the plurality of light-emitting diodes installed on the tactile sensor module 410 sequentially emit light, and receives, through the lower layer connector, signals according to the amounts of light received by the plurality of photodiodes while the plurality of light-emitting diodes emit light; and a trained artificial neural network 430 that receives, through the MCU 420, the amounts of light received by the plurality of photodiodes and estimates the 3-axis force and 3-axis torque applied to the tactile sensor module 410.

The tactile sensor module 410 of FIG. 4 may be the tactile sensor module 100 of FIGS. 1a to 1c or the tactile sensor module 210 of FIG. 2. The trained artificial neural network 430 may be an artificial neural network trained, through the tactile sensor module training system of FIG. 2, to estimate the 3-axis force and 3-axis torque applied to the tactile sensor module 410 based on information on the amounts of light received by the plurality of photodiodes while the plurality of light-emitting diodes of the tactile sensor module of the present disclosure sequentially emit light.

The tactile sensor module 410 is connected to the MCU 420 through the upper layer connector and the lower layer connector. The MCU 420 outputs a control signal through the upper layer connector to the tactile sensor module 410 so that, in each cycle, the first light-emitting diode 113-1 to the fourth light-emitting diode 113-4 are sequentially lit. When the first light-emitting diode 113-1 to the fourth light-emitting diode 113-4 are lit, light is incident on the first photodiode 123-1 and the second photodiode 123-2, and the first photodiode 123-1 and the second photodiode 123-2 transmit signals corresponding to the amounts of light received to the MCU 420 through the lower layer connector. Through this, the MCU 420 may obtain information on the amounts of light received (S11, S12, S21, S22, S31, S32, S41, and S42) by the two photodiodes when the four light-emitting diodes are lit in each cycle, and provide the information to the trained artificial neural network 430.

The trained artificial neural network 430 may estimate the 3-axis force and 3-axis torque applied to the tactile sensor module 410 based on information received from the MCU 420 on the amounts of light received (S11, S12, S21, S22, S31, S32, S41, and S42) by the plurality of photodiodes when the plurality of light-emitting diodes are lit, and may provide the estimation to the MCU 420.

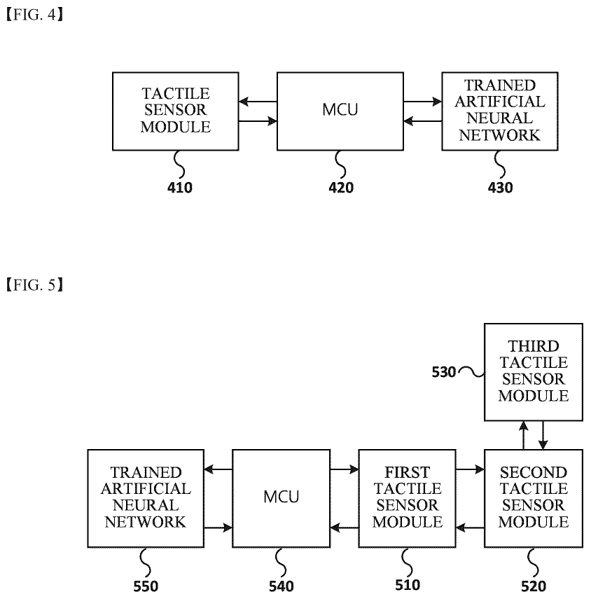

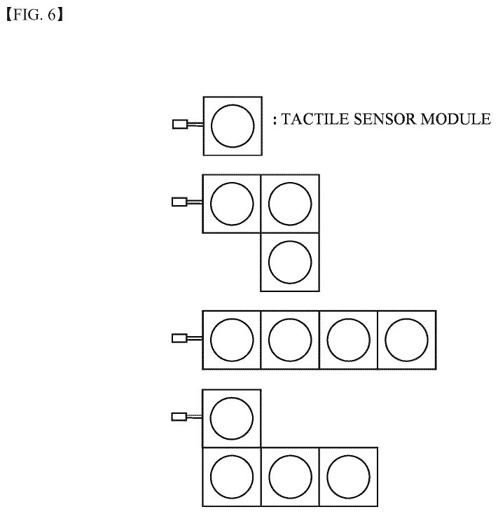

FIG. 5 is a block diagram showing a tactile sensor system composed of a tactile sensor module array according to the present disclosure.

The tactile sensor system includes: a first tactile sensor module 510 including a first upper layer portion having a first upper layer connector, a first upper layer socket, and a first plurality of light-emitting diodes installed thereon, and a first lower layer portion having a first lower layer connector, a first lower layer socket, and a first plurality of photodiodes disposed to face the first plurality of light-emitting diodes installed thereon; a second tactile sensor module 520 including a second upper layer portion having a second upper layer connector and a second plurality of light-emitting diodes installed thereon, and a second lower layer portion having a second lower layer connector and a second plurality of photodiodes disposed to face the second plurality of light-emitting diodes installed thereon, wherein the second upper layer connector and the second lower layer connector are connected to the first upper layer socket and the first lower layer socket, respectively; an MCU 540 that is connected to the first tactile sensor module 510 through the first upper layer connector and the first lower layer connector, outputs a control signal through the first upper layer connector so that the first plurality of light-emitting diodes and the second plurality of light-emitting diodes installed on the first tactile sensor module 510 and the second tactile sensor module 520 sequentially emit light, and receives, through the first lower layer connector, signals according to the amounts of light received by the first and second pluralities of photodiodes while the first and second pluralities of light-emitting diodes emit light; and a trained artificial neural network 550 that receives, through the MCU 540, the amounts of light received by the first and second pluralities of photodiodes and estimates the 3-axis force and 3-axis torque applied to the first and second tactile sensor modules 510 and 520.

In the tactile sensor system, a third tactile sensor module 530 may be further connected to the second tactile sensor module 520, and to this end, the second tactile sensor module 520 may further include a second upper layer socket and a second lower layer socket. Each of the tactile sensor modules 510, 520, and 530 of FIG. 5 may be the tactile sensor module 100 of FIGS. 1a to 1c or the tactile sensor module 210 of FIG. 2.

Preferably, as shown in FIGS. 1b and 1c, each of the tactile sensor modules 510, 520, and 530 may have an upper layer connector and a lower layer connector installed on one side, and an upper layer socket and a lower layer socket installed on each of the remaining three sides. The upper and lower layer sockets installed on the three sides may be connected in parallel to allow a subsequent tactile sensor module to be connected to any one of the three sides.

When three tactile sensor modules are connected, the MCU 540 may transmit a control signal, through the first upper layer connector of the first tactile sensor module 510, for sequentially lighting the plurality of light-emitting diodes installed on each of the first to third tactile sensor modules 510 to 530.

The first tactile sensor module 510 takes bits assigned to itself from control signals provided by the MCU 540, sequentially lights the first plurality of light-emitting diodes, and delivers the remaining bits to the second tactile sensor module 520. Likewise, the second tactile sensor module 520 takes bits assigned to itself from the control signals transmitted from the first tactile sensor module 510, sequentially lights the second plurality of light-emitting diodes, and delivers the remaining bits to the third tactile sensor module 530. When a fourth tactile sensor module (not shown) is connected subsequent to the third tactile sensor module 530, the third tactile sensor module 530 may take bits assigned to itself from the control signals transmitted from the second tactile sensor module 520, and may deliver the remaining bits to the fourth tactile sensor module.

While the first plurality of light-emitting diodes of the first tactile sensor module 510 are lit, information on the amounts of light received by the first plurality of photodiodes is transmitted to the MCU 540 through the first lower layer connector. While the second plurality of light-emitting diodes of the second tactile sensor module 520 are lit, information on the amounts of light received by the second plurality of photodiodes is transmitted to the first tactile sensor module 510 through the second lower layer connector and then transmitted to the MCU 540 through the first lower layer connector. Likewise, information on the amounts of light received by the third plurality of photodiodes of the third tactile sensor module 530 is transmitted to the MCU 540 through the second tactile sensor module 520 and the first tactile sensor module 510.

As such, in each cycle, the MCU 540 may output a control signal through the upper layer connector to sequentially light the respective plurality of light-emitting diodes of the first tactile sensor module 510 to the third tactile sensor module 530; obtain, through the lower layer connector, information on the amounts of light received by the respective plurality of photodiodes when the respective plurality of light-emitting diodes are lit; and provide the information to the trained artificial neural network 550.

The trained artificial neural network 550 may estimate the 3-axis force and 3-axis torque applied to a corresponding tactile sensor module based on information received from the MCU 540 on the amounts of light received by the plurality of photodiodes when the respective plurality of light-emitting diodes of each tactile sensor module are lit, and may provide the estimated 3-axis force and 3-axis torque to the MCU 540.

As described above, in the present disclosure, since the MCU 540 can share signal lines to transmit control signals to the plurality of tactile sensor modules and collect information on the amounts of light received from the plurality of tactile sensor modules, a complicated wiring design is not required even if the number of tactile sensor modules constituting the tactile sensor system increases.

In addition, since the MCU 540 may sequentially drive the first to third tactile sensor modules 510 to 530 and sequentially obtain information on the amounts of light received from the first to third tactile sensor modules 510 to 530, each tactile sensor module can be addressed.

FIG. 6 is a diagram showing various embodiments of the tactile sensor module array according to the present disclosure. A plurality of tactile sensor modules may be sequentially connected to form a tactile sensor module array. In this case, a subsequent tactile sensor module may be connected in any direction to one of the three sides of a preceding tactile sensor module, thereby allowing the shape of the tactile sensor module array to be freely expanded.

The elements, blocks, or routine descriptions in the flowcharts described in the specification and/or shown in the accompanying drawings should be understood to represent modules, segments, or portions of code, which include one or more executable instructions for implementing specified logical functions or elements. Alternative implementations are included within the scope of the present disclosure, in which elements or functions may be executed out of order from that shown or discussed, including substantially concurrently or in reverse order, depending on the functionality involved.

Many variations and modifications can be made to the above-described embodiments without departing from the spirit and scope of the disclosure. All such modifications and variations are intended to be included within the scope of the present disclosure and protected by the following claims.

Although the present disclosure has been described with reference to specific embodiments and drawings, it is provided for a more general understanding. The disclosure is not limited to the described embodiments, and various modifications and variations can be made by one of ordinary skill in the art without departing from the spirit and scope of the disclosure.

Therefore, the spirit and scope of the present disclosure should not be limited to the embodiments described above, but should be defined by the appended claims and their equivalents.

1. A tactile sensor module comprising:
a plate-shaped upper layer portion;
a plate-shaped lower layer portion disposed to face the upper layer portion; and
a transparent buffer portion filled between the upper layer portion and the lower layer portion,
wherein the upper layer portion comprises an upper layer connector disposed on one side thereof and a plurality of light-emitting diodes configured to be sequentially lit according to a control signal input to the upper layer connector, and
wherein the lower layer portion comprises a lower layer connector disposed on one side thereof and a plurality of photodiodes configured to receive light emitted from the plurality of light-emitting diodes and to output signals corresponding to respective amounts of received light through the lower layer connector.

2. The tactile sensor module of claim 1, wherein:
the upper layer portion further comprises an upper layer socket to which a subsequent tactile sensor module is connected, on at least one of remaining sides other than the side on which the upper layer connector is installed, and
the lower layer portion further comprises a lower layer socket to which a subsequent tactile sensor module is connected, on at least one of remaining sides other than the side on which the lower layer connector is installed.

3. The tactile sensor module of claim 2, wherein:
the upper layer portion further comprises at least two upper layer sockets connected in parallel to each other on at least two sides, and
the lower layer portion further comprises at least two lower layer sockets connected in parallel to each other on at least two sides.

4. The tactile sensor module of claim 1, wherein the transparent buffer portion is made of a transparent and elastic material to be deformed when a force or a torque is applied to any position of at least one of the upper layer portion and the lower layer portion.

5. A tactile sensor module training system comprising:
a tactile sensor module comprising an upper layer portion that includes an upper layer connector disposed on one side thereof and a plurality of light-emitting diodes configured to be sequentially lit according to a control signal input to the upper layer connector, and a lower layer portion that includes a lower layer connector disposed on one side thereof and a plurality of photodiodes configured to receive light emitted from the plurality of light-emitting diodes and to output signals corresponding to respective amounts of received light through the lower layer connector;
an MCU configured to output a control signal so that the plurality of light-emitting diodes installed on the tactile sensor module sequentially emit light, and to receive signals corresponding to amounts of light received by the plurality of photodiodes while the plurality of light-emitting diodes sequentially emit light;
an actual value output unit configured to output a 3-axis force and a 3-axis torque actually applied to the tactile sensor module; and
an artificial neural network configured to be trained to minimize an error between an estimated 3-axis force and 3-axis torque and an actual 3-axis force and 3-axis torque provided by the actual value output unit, wherein the artificial neural network estimates the 3-axis force and the 3-axis torque applied to the tactile sensor module based on information on the amounts of light received by the plurality of photodiodes according to emission of the plurality of light-emitting diodes input through the MCU.

6. The tactile sensor module training system of claim 5, wherein the tactile sensor module is connected to the MCU through the upper layer connector and the lower layer connector.

7. The tactile sensor module training system of claim 5, wherein the actual value output unit comprises a load cell configured to receive the 3-axis force and the 3-axis torque that are equally applied to the tactile sensor module, and to measure the applied 3-axis force and 3-axis torque.

8. The tactile sensor module training system of claim 5, wherein the actual value output unit comprises an actuator configured to determine the 3-axis force and the 3-axis torque applied to the tactile sensor module and to apply them to the tactile sensor module.

9. The tactile sensor module training system of claim 5, wherein the actual value output unit comprises a storage means configured to store the 3-axis force and the 3-axis torque applied to the tactile sensor module.

10. The tactile sensor module training system of claim 5, wherein:
the upper layer portion further comprises an upper layer socket to which a subsequent tactile sensor module is connected on at least one of the remaining sides other than the side on which the upper layer connector is installed, and
the lower layer portion further comprises a lower layer socket to which a subsequent tactile sensor module is connected on at least one of the remaining sides other than the side on which the lower layer connector is installed.

11. The tactile sensor module training system of claim 10, wherein:
the upper layer portion further comprises at least two upper layer sockets connected in parallel to each other on at least two sides, and
the lower layer portion further comprises at least two lower layer sockets connected in parallel to each other on at least two sides.

12. A tactile sensor system comprising:
a first tactile sensor module comprising a first upper layer portion that includes a first upper layer connector disposed on one side thereof and a first plurality of light-emitting diodes configured to be sequentially lit according to a control signal input to the first upper layer connector, and a first lower layer portion that includes a first lower layer connector disposed on one side thereof and a first plurality of photodiodes configured to receive light emitted from the first plurality of light-emitting diodes and to output signals according to respective amounts of light received through the first lower layer connector;
an MCU configured to output a control signal so that the first plurality of light-emitting diodes installed on the first tactile sensor module sequentially emit light, and to receive signals corresponding to amounts of light received by the first plurality of photodiodes while the first plurality of light-emitting diodes sequentially emit light; and
a trained artificial neural network configured to estimate a 3-axis force and a 3-axis torque applied to the first tactile sensor module based on information on the amounts of light received by the first plurality of photodiodes according to emission of the first plurality of light-emitting diodes input through the MCU.

13. The tactile sensor system of claim 12, wherein the first tactile sensor module is connected to the MCU through the first upper layer connector and the first lower layer connector.

14. The tactile sensor system of claim 12, wherein:
the first upper layer portion further comprises a first upper layer socket to which a subsequent tactile sensor module is connected on at least one of the remaining sides other than the side on which the first upper layer connector is installed, and
the first lower layer portion further comprises a first lower layer socket to which a subsequent tactile sensor module is connected on at least one of the remaining sides other than the side on which the first lower layer connector is installed.

15. The tactile sensor system of claim 14, further comprising:
a second tactile sensor module comprising a second upper layer portion that includes a second upper layer connector disposed on one side thereof and connected to the first upper layer socket, and a second plurality of light-emitting diodes configured to be sequentially lit according to a control signal input to the second upper layer connector; and
a second lower layer portion that includes a second lower layer connector disposed on one side thereof and connected to the first lower layer socket, and a second plurality of photodiodes configured to receive light emitted from the second plurality of light-emitting diodes and to output signals according to respective amounts of light received through the second lower layer connector.

16. The tactile sensor system of claim 15, wherein the MCU is configured to transmit, through the first upper layer connector of the first tactile sensor module, a control signal for sequentially lighting the first plurality of light-emitting diodes and the second plurality of light-emitting diodes installed on the first tactile sensor module and the second tactile sensor module, respectively.

17. The tactile sensor system of claim 16, wherein the first tactile sensor module is configured to take bits assigned to itself from the control signal provided by the MCU, sequentially light the first plurality of light-emitting diodes, and deliver remaining bits to the second tactile sensor module.

18. The tactile sensor system of claim 15, wherein the MCU is configured to receive, through the first lower layer connector of the first tactile sensor module, information on the amounts of light received by the first plurality of photodiodes and the second plurality of photodiodes installed on the first tactile sensor module and the second tactile sensor module, respectively.

19. The tactile sensor system of claim 15, wherein the trained artificial neural network is configured to estimate a 3-axis force and a 3-axis torque applied to the second tactile sensor module based on information on the amounts of light received by the second plurality of photodiodes according to emission of the second plurality of light-emitting diodes input through the MCU.

20. The tactile sensor system of claim 14, wherein:
the first upper layer portion further comprises at least two first upper layer sockets connected in parallel to each other on at least two sides, and
the first lower layer portion further comprises at least two first lower layer sockets connected in parallel to each other on at least two sides.
